(19) United States
(12) Patent Application Publication
(10) Pub. No.: US 2023/0313851 A1
(43) Pub. Date: Oct. 5, 2023

(54) Method for Operating a Fluid Supply System

(71) Applicant: ZF Friedrichshafen AG, Friedrichshafen (DE)

(72) Inventors: Markus Terwart, Thundorf (DE); Robert Weissenrieder, Knetzgau (DE); Lukas Spath, Schonungen (DE)

(21) Appl. No.: 18/194,177

(22) Filed: Mar. 31, 2023

(30) Foreign Application Priority Data
Apr. 1, 2022 (DE) 10 2022 203 230.6

(51) Int. Cl. F16D 48/02

(52) U.S. Cl. CPC F16D 48/02; F16D 2500/1026; F16D 2500/5014; F16D 2500/70406; F16D 2048/0257

(57) ABSTRACT

A method for operating a fluid supply system for supplying fluid to an actuator and a component of a motor vehicle drive train, where the actuator and the component are connected in parallel within a supply path of the fluid supply system, may include increasing a pressure of the fluid in the supply path from a low base pressure level (associated with a non-actuated condition of the actuator) when the actuator is to be actuated. The method may further include determining, when the actuator is not to be actuated, whether a criterion is present, indicating an insufficient supply of the fluid in the supply path to the component. Additionally, the method may include increasing the pressure of the fluid in the supply path from the low base pressure level when the criterion is present.

### CROSS-REFERENCE TO RELATED APPLICATION

The present application is related and has right of priority to German Patent Application No. 10 2022 203 230.6 filed on Apr. 1, 2022, the entirety of which is incorporated by reference for all purposes.

### FIELD OF THE INVENTION

The invention relates generally to a method for operating a fluid supply system, more particularly, a method for operating a fluid supply system for integral parts of a motor vehicle drive train, where at least one actuator is supplied with a fluid in a supply path within the fluid supply system and at least one component is also supplied with the fluid in the supply path in parallel to the at least one actuator, and where the pressure of the fluid in the supply path is increased at least when the at least one actuator is to be actuated, starting from a low base pressure level, which is associated with a non-actuated condition of the at least one actuator. The invention also relates generally to a control unit, a computer program product, a data carrier, and a fluid supply system.

### BACKGROUND

In fluid technology, fluid supply systems are known for supplying one or more actuator(s) with fluid in order to generate actuating motions of the particular actuator by, and as a function of, a pressure of the fluid. The fluid is frequently a hydraulic fluid, which is usually present in the form of oil. At times, in addition to a particular actuator, other types of components are also supplied with the fluid in order to lubricate and/or cool these components. These components are bearing points or also a particular wet-running separating clutch, which is actuated by the particular actuator within the scope of an execution of the actuating motions of the actuator. The supply to these further components thus, also partially depends on the pressure of the fluid in the supply system.

A fluid supply system is derived from US 2012/217121 A1, the fluid supply system being in a motor vehicle drive train at a hybrid drive device. In the supply system, a hydraulic actuator is supplied with fluid in the form of oil in a supply path, wherein the actuator is in the form of a multi-disk clutch for actuating a wet-running friction clutch. The actuator includes an actuating piston, which, together with a housing part, delimits a pressure chamber. By supplying this pressure chamber with the fluid, an actuating motion of the actuating piston counter to a spring element is initiated as a function of a pressure of the fluid. If a pressure of the fluid is increased starting from a base pressure level to such an extent that a spring force defined by the spring element is overcome, the actuating motion of the actuating piston is initiated and a pressing-together of a disk pack of the multi-disk clutch is induced. Bearing points of the hybrid drive device and a clutch housing of the multi-disk clutch, as components, are also supplied with the fluid in the supply path in parallel to the supply to the actuator. The clutch housing is supplied with different amounts of fluid as a function of an actuation status of the multi-disk clutches, wherein a setting range sets the amount of fluid.

### SUMMARY OF THE INVENTION

Proceeding from the above-described prior art, the problem addressed by the present invention is that of realizing a reliable operation of at least one actuator in a fluid supply system, wherein a sufficient supply to at least one component is also to be simultaneously ensured in the fluid supply system.

According to the example aspects of the present subject matter, at least one actuator is supplied with a fluid in a supply path within a fluid supply system, the pressure of the fluid in the supply path being increased when the at least one actuator is to be actuated, starting from a low base pressure level, which is associated with a non-actuated condition of the at least one actuator. In the supply path, at least one component is also supplied with the fluid in parallel to or with the at least one actuator.

In the method according to the invention, a fluid is therefore supplied in a supply path in a fluid supply system that is, more particularly, liquid and, particularly preferably, oil, thus allowing the fluid supply system to be a hydraulic system. Alternatively, the fluid could even be a gaseous medium, such as, for example, compressed air, and so the fluid supply system is present as a pneumatic system in this case. Within the supply path, the fluid is fed, on one hand, to at least one actuator and is used for controlling this actuator by increasing a pressure of the fluid in the supply path starting from a base pressure level when the particular actuator is to be actuated. The base pressure level is associated with a non-actuated condition of the at least one actuator. The base pressure level is, more particularly, a pre-filling pressure level at which a basic supply to the actuator and/or to the components within the supply path is maintained apart from or outside of an actuation of the at least one actuator. The pre-filling pressure is used for bleeding the actuator actuating path. The basic supply is used for cooling and lubricating the component.

Accordingly, the at least one actuator is a fluid-actuated actuator, which is present as a hydraulic actuator for the case in which the fluid is in the form of a liquid. It is particularly preferred when the actuator is a hydraulic control actuator, which generates a translatory actuating motion when appropriately pressurized with the fluid and, more particularly, is provided for the automatic or automated actuation of a clutch. The clutch is, more particularly, a friction clutch and, preferably, a multi-disk clutch. The hydraulic control actuator is, more particularly, a hydraulic actuating cylinder, in the case of which an actuating piston is located in a housing so as to be displaceable in a translatory manner and, with the housing, delimits an intermediate pressure chamber. This pressure chamber is supplied fluid from the supply path of the fluid supply system.

When the at least one actuator is to be actuated, the pressure of the fluid in the supply path is increased. It would be conceivable within the scope of the invention to set different, higher pressure levels in the course of the actuation of the at least one actuator. More particularly, when the at least one actuator is to be actuated, the pressure is initially increased starting from the base pressure level to a higher pressure level, which represents a rapid filling phase. In the course of this rapid filling phase, the at least one actuator is filled with the fluid as rapidly as possible (rapid filling) in order to also be able to effectuate a particular actuating motion of the at least one actuator as rapidly as possible. Subsequent to the rapid filling phase, more particularly, one or more further pressure level(s) is/are set, which is/are usually below the pressure level of the rapid filling phase, since the highest pressure level is generally reached in the rapid filling phase. The rapid filling phase is necessary when the compressive force to be set must be higher than the restoring force of the actuator and, as a result, is used for initiating an actuating motion of the at least one actuator. This initiation of the actuating motion requires, more particularly, that a counter force of a spring element initially be overcome. The spring element preloads an actuating element, more particularly an actuating piston, of the actuator into a home position, which corresponds to a non-actuated condition of the actuator. The pressure level of the rapid filling phase is to be selected to be appropriately high.

On the other hand, at least one component is also supplied with fluid from the supply path. This is carried out, more particularly, in order to lubricate and/or cool the at least one component. In this respect, the fluid functions as a lubricant and/or as a coolant in the supply to the at least one component. Due to the supply to the at least one component taking place in parallel to the at least one actuator from the, therefore, shared supply path, the supply to the at least one component also takes place at the same pressure at which the supply to the at least one actuator is currently also carried out. The at least one component is, more particularly, a component in a motor vehicle drive train, wherein the component is preferably present as a bearing point to be lubricated or also as a component to be cooled. In the latter case, the component is alternatively also a wet-running friction clutch, which is actuatable via the actuator.

According to another example aspect of the present invention, the invention now encompasses the technical teaching that it is determined within the scope of the method according to the invention whether at least one criterion representing an insufficient supply of fluid to the at least one component is present. When the presence of at least one criterion is detected, a measure is initiated, within the scope of which the pressure of the fluid in the supply path is increased starting from the base pressure level even when the at least one actuator is not to be actuated. In other words, it is therefore checked within the scope of the method whether at least one criterion has been met, the criterion indicating that the at least one component is insufficiently supplied with fluid. If it is detected that at least one criterion is present, a measure is subsequently initiated. In the course of this measure, the pressure of the fluid in the supply path is increased starting from the base pressure level even though the at least one actuator is not to be actuated.

Such an operation of a fluid supply system has the advantage that an insufficient supply to the at least one component is countered in a targeted manner as a result and, thereby, damage to or even failure of the component due to the insufficient supply is prevented. This is the case because the at least one component is also supplied at a higher pressure of the fluid due to the fact that, in the presence of at least one criterion that indicates an insufficient supply of fluid, a pressure increase in the supply path is effectuated in a targeted manner and apart from an actuation of the at least one actuator to be carried out. It is possible to increase pressure starting from the base pressure level to a pressure level without significantly disruptively affecting the control of the at least one actuator in the operating sequence or significantly disruptively affecting an operating sequence of the overall system or adversely affecting an efficiency of the overall system for the long term. Overall, an actuation of the at least one actuator is therefore achievable in the fluid supply system by a pressure increase during normal operation, in the course of which the supply to the at least one component then also takes place at the higher pressure, wherein an at least longer lasting insufficient supply to the at least one component is preventable apart from the actuation of the at least one actuator by also effectuating a pressure increase in a targeted manner.

In the method according to the invention, the pressure increase taking place apart from the actuation of the at least one actuator to be carried out is implemented for the case in which the measure was initiated after the presence of at least one criterion was detected. Each of the at least one criterion is intended as a triggering condition within the scope of the method according to the invention when the criterion is detected as being present already looking ahead to an imminent insufficient supply to the at least one component, directly at the onset of the insufficient supply to the at least one component, or only after a certain amount of time has elapsed since the onset of an insufficient supply.

According to one embodiment of the invention, at least one criterion is declared as present when it is detected that an associated limit value has been exceeded by an ascertained fluid requirement of the at least one component. In this case, a fluid requirement of the at least one component is therefore determined and compared with an associated limit value. If the need for fluid exceeds this limit value, the criterion is output as having been met and, according to the invention, the measure is subsequently initiated. The coupling of the presence of the at least one criterion to the fluid requirement has the advantage that the conditions prevailing with respect to the supply to the at least one component are therefore directly incorporated.

In one refinement of the aforementioned embodiment, the fluid requirement is ascertained by determining a fluid deficit in an inflow-side area of the at least one component. In order to ascertain the fluid requirement, it is therefore determined whether a shortage of fluid has arisen in an inflow-side area of the at least one component, i.e., upstream from the at least one component in the flow direction of the fluid. Advantageously, an insufficient supply of fluid to the at least one component is therefore directly inferred.

In one variant of the invention that is an alternative to, or preferably supplements the aforementioned refinement, the fluid requirement is determined by ascertaining a fill level of fluid in an inflow-side area of the at least one component. In this case as well, an insufficient supply of fluid to the at least one component is detectable by observing a fill level of fluid in the inflow-side area of the component, i.e., upstream from the at least one component in the flow direction of the fluid. Preferably, a fill level of a reservoir is ascertained, the reservoir being provided for the fluid in the inflow-side area of the component. This type of reservoir is, more particularly, a line volume, which is present on the inflow side of the at least one component and forms a collecting chamber. It is particularly preferred when the fill level is ascertained on the basis of a determination of an amount of fluid flowing into the area and/or flowing out of the area, since this enables a problem-free determination of the fill level. Within the scope of the invention, both the fluid deficit in the inflow-side area and also the fill level of fluid are preferably determined in order to ascertain the fluid requirement.

According to one advantageous option of the invention, the particular determination is carried out as a calculation and, in so doing, within the scope of a simulation. This has the advantage that the particular determination therefore takes place without the need for additional sensors at the particular component, wherein the actually prevailing conditions are simultaneously replicated with sufficiently high accuracy due to the simulation.

In another embodiment of the invention, operating parameters are incorporated into the check for the presence of the at least one criterion. These operating parameters are, more particularly, the parameters that affect the supply of fluid to the at least one component. These are preferably parameters that relate to the configuration of the supply line extending to the at least one component. This is, more particularly, a geometry of the particular supply line (line cross-section, configuration of nozzles, hydraulic resistances, etc.). However, other parameters that affect the supply of the fluid to the at least one component are also decided or defined, such as, for example, a particular rotational speed of a component guiding the fluid, a current viscosity of the fluid, etc. Moreover, a dependence of a fluid requirement of the at least one component, such as, for example, a rotational speed dependence and/or a load dependence, is also replicable.

Within the scope of the invention, as an alternative or a supplement to a determination of the fluid requirement, at least one criterion is also declared as having been met when an operating parameter exceeds or falls below an associated limit. This is advantageous when it is already known on the basis of calculations or tests that this exceedance or falling below will result in an insufficient supply to the at least one component. In this way, a rotational speed of a component guiding the fluid, for example, a shaft that forms a supply line for the fluid in a through hole, is decided or defined for the initiation of the measure when it is known that a supply of the fluid to the at least one component is made difficult at a certain rotational speed of the component due to the centrifugal force effect and, as a result, the insufficient supply arises or is imminent.

According to one option of the invention, the pressure is increased within the scope of the measure in the form of a control with pulse width modulation. Advantageously, unintentional actuations of the at least one actuator and/or efficiency losses at the at least one actuator are/is therefore avoidable to the greatest extent possible due to the, therefore, pulsed pressure increases and the, therefore, short control times. Simultaneously, a sufficient supply to the at least one component is achievable on average. The reason for this is that an amount of fluid is supplied depending on the pressure of the fluid in the course of the measure in phases of the pressure increase, by which a shortage is compensated for in the course of the measure in phases in which pressure is not increased.

In yet another embodiment of the invention, it is queried upon initiation and prior to an execution of the measure whether at least one abort condition preventing the execution of the measure is met. If at least one abort condition is present, the execution of the measure is aborted. As a result, a plausibility check is realized in order to check prior to the execution of the measure whether consequences that are more serious than an insufficient supply to the at least one component would arise due to the execution of the measure. At a motor vehicle drive train, for example, safety-relevant restrictions or even imminent losses of comfort are taken into account as abort conditions.

According to one option of the invention, an actuating cylinder of each particular associated separating clutch, as the actuator, and a respective bearing point and/or the particular associated separating clutch, as the component, are supplied with the fluid. The separating clutch and the respective bearing point are, more preferably, integral parts of a motor vehicle drive train. The separating clutch is provided, more particularly, as a wet-running multi-disk clutch for coupling a transmission input of a motor vehicle transmission to an upstream internal combustion engine. Bearing points, as components, are preferably supplied for the purpose of lubrication, where the bearing points support two shafts in a manner enabling the two shafts rotation relative to each other. The shafts are situated coaxially to each other and are connectable to each other via the separating clutch for conjoint rotation. The one shaft is equipped with an axially extending bore, via which the fluid is guidable to a shaft end of the same shaft. A collecting chamber for the fluid is defined between the shaft end of the one shaft and of the other shaft. The fluid leaves the collecting chamber and reaches the bearing points to be lubricated. Only reduced amounts of fluid reach this collecting chamber more particularly at higher rotational speeds of the one shaft due to the centrifugal force effect. In the extreme case, this even results in air getting sucked into the collecting chamber. Due to the pressure increase within the scope of the method according to the invention, a sufficient resupply of fluid into the collecting chamber is therefore achievable apart from an actuation of the actuating cylinder of the separating clutch.

In one refinement of the aforementioned option, the pressure is increased within the scope of the measure from the base pressure level to an actuating pressure level at which a touch point of the associated separating clutch is approached via the respective actuating cylinder of the associated separating clutch. As a result, a pressure increase is carried out to an extent to which fluid is guided, due to the pressure, to the component to be supplied, wherein, simultaneously, there is no, or no noteworthy, torque transmission via the separating clutch at the touch point of the separating clutch.

Alternatively, the pressure is increased within the scope of the measure from the base pressure level to an intermediate pressure level, which is below a minimum actuating pressure at which a particular actuating motion is initiated by the respective actuating cylinder. Advantageously, although this results in an increase of the pressure, due to which the supply of fluid to the at least one component is improved, this does not simultaneously induce a translatory actuating motion of the respective actuating cylinder. In this way, the pressure increase is carried out within a scope in which a preload force of a spring element is not overcome despite the pressure increase, the spring element preloading an actuating piston of the actuating cylinder into a home position.

The subject matter of the invention is also a control unit, which is more particularly a transmission control unit of a motor vehicle transmission of a motor vehicle drive train.

This control unit, which is associated with a fluid supply system, within which fluid is supplied in a supply path to at least one actuator and to at least one component, triggers an increase of a pressure of the fluid when the at least one actuator is to be actuated, starting from a low base pressure level associated with a non-actuated condition of the at least one actuator. Moreover, the control unit checks whether at least one criterion indicating an insufficient supply of fluid to the at least one component is present and, when the presence of at least one criterion is detected, initiates a measure, within the scope of which the pressure of the fluid is increased from the base pressure level, even when the at least one actuator is not to be actuated. It is particularly preferred when the control unit also implements one or multiple of the above-described variants of a method.

The approach according to the invention is also embodiable as a computer program product, which, when running on a processor, for example, a processor of an aforementioned control unit, instructs the processor from the software point of view to carry out the assigned method steps, which are subjects of the invention. In this context, a machine-readable medium, on which an above-described computer program product is retrievably stored, is also a subject of the invention.

The invention further relates to a fluid supply system, which is operable according to a method according to one or more of the above-described variants in order to supply at least one actuator and at least one component with fluid. The fluid supply system preferably supplies integral parts of a motor vehicle drive train. The at least one actuator is more particularly an actuating cylinder of a separating clutch, which is preferably a wet-running multi-disk clutch. The at least one component is present, more particularly, as a respective bearing point, via which shafts, which are connectable to each other via the separating clutch for conjoint rotation, are mounted so as to be rotatable relative to each other. Moreover, the separating clutch itself is preferably also supplied with the fluid for cooling as a component.

The invention is not limited to the specified combination of features of the other independent claims or the claims dependent thereon. In addition, individual features are combinable with one another, provided they arise from the claims, the description of a preferred embodiment of the invention which follows, or directly from the drawings. References in the claims to the drawings via the use of reference characters is not intended to limit the scope of protection of the claims.

### BRIEF DESCRIPTION OF THE DRAWINGS

One advantageous embodiment of the invention, which is explained in the following, is shown in the drawings, in which:

FIG. 1 shows a sectional view of a fluid supply system of a motor vehicle drive train;

FIG. 2 shows a detailed view of the fluid supply system from FIG. 1;

FIG. 3 shows a flow chart of a method according to the invention for operating the fluid supply system from FIGS. 1 and 2; and

FIG. 4 shows a diagram of various pressure curves.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

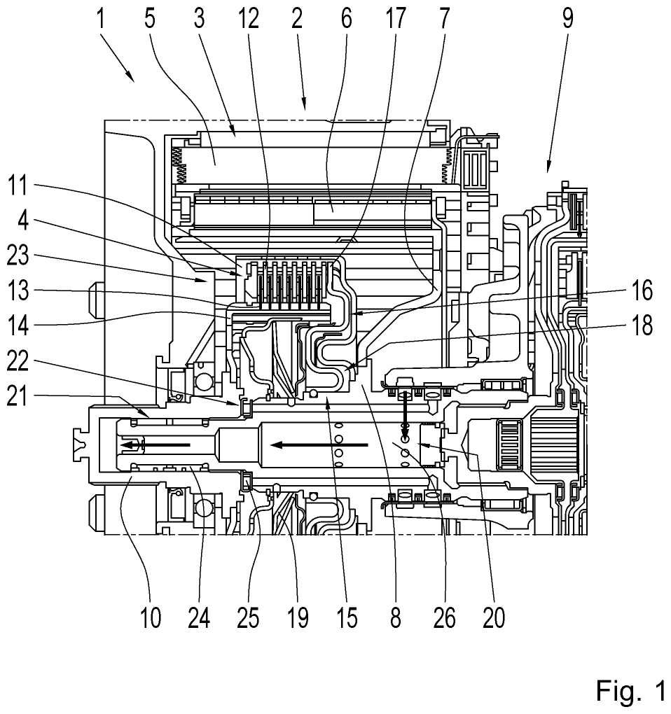

FIG. 1 shows a sectional view of an area of a motor vehicle drive train 1, which is intended for use in a hybrid vehicle. The motor vehicle drive train 1 is shown at a hybrid module 2, which includes an electric machine 3 and a separating clutch 4. The electric machine 3 is made up of a stator 5 and a rotor 6. The rotor 6 of the electric machine 3 is connected to a rotor hub 7 for conjoint rotation, where the rotor hub 7 in addition to the rotor 6 are also being permanently connected to a shaft 8 for conjoint rotation. In the present case, the shaft 8 is a transmission input shaft of a motor vehicle transmission 9, which is only partially shown in FIG. 1.

The separating clutch 4 is a wet-running multi-disk clutch. The separating clutch 4 is in a disengaged condition when not actuated and, when actuated, establishes a corotational connection between the shaft 8 and a shaft 10. The shaft 10 is arranged coaxially to the shaft 8 and establishes a connection within the motor vehicle drive train 1 to an internal combustion engine, which is not shown in greater detail in the present case. The separating clutch 4 includes an outer disk carrier 11 in or on which multiple outer clutch disks 12 are located in a rotationally fixed and axially displaceable manner, the outer disk carrier 11 being connected to the shaft 8 for conjoint rotation. In addition, inner clutch disks 13 are arranged so as to alternate axially with the outer clutch disks 12 and, together with the outer clutch disks 12, form a disk pack of the separating clutch 4. The inner clutch disks 13 are specifically located in or on an inner disk carrier 14 in a rotationally fixed and axially displaceable manner. The inner disk carrier 14 is connected to the shaft 10 for conjoint rotation.

An actuation of the separating clutch 4 and, thereby, a coupling of the shafts 8 and 10 essentially for conjoint rotation takes place in the present case by the disk pack, particularly by outer clutch disks 12 and inner clutch disks 13 of the disk pack being pressed together axially and, as a result, forming a friction-locking connection between the outer clutch disks 12 and the inner clutch disks 13. For this purpose of pressing the outer clutch disks 12 and the inner clutch disks 13 together and, thereby, actuating the separating clutch 4, an actuator 15 in the form of a hydraulic actuating cylinder 16 is associated with the separating clutch 4.

As is apparent in FIG. 1, the actuating cylinder 16 has an actuating piston 17, which is axially displaceably located on the shaft 8 and, together with the shaft 8 and the outer disk carrier 11, delimits a pressure chamber 18. The actuating piston 17 is preloaded into a home position via a spring element 19, which is a plate spring in the present case and is located axially on a side of the actuating piston 17 facing away from the pressure chamber 18. In the home position, the actuating piston 17 does not act axially upon the disk pack of the separating clutch 4. For actuating the actuator 15, the pressure chamber 18 is pressurized with fluid in the form of oil. At a certain pressure level of the fluid, the pressurization results in an axial displacement of the actuating piston 17 counter to the spring element 19, whereupon the actuating piston 17 axially presses the outer clutch disks 12 and the inner clutch disks 13 together and, as a result, effectuates the actuation of the separating clutch 4.

A supply to the actuating cylinder 16 and, thereby, also to the pressure chamber 18 takes place in the present case in a fluid supply system 20 in which the fluid is guided at a particular set pressure to the pressure chamber 18 in a supply path. In addition, a supply to components 21, 22, 23 of the motor vehicle drive train 1 also takes place within the same supply path of the fluid supply system 20. The components 21, 22 are bearing points 24, 25 and the component 23 is the separating clutch 4.

Each of the bearing points 24, 25 is present as an anti-friction bearing. The bearing point 24 radially supports the shaft 8 relative to the shaft 10, while the bearing point 25 axially supports the shaft 8 relative to the shaft 10.

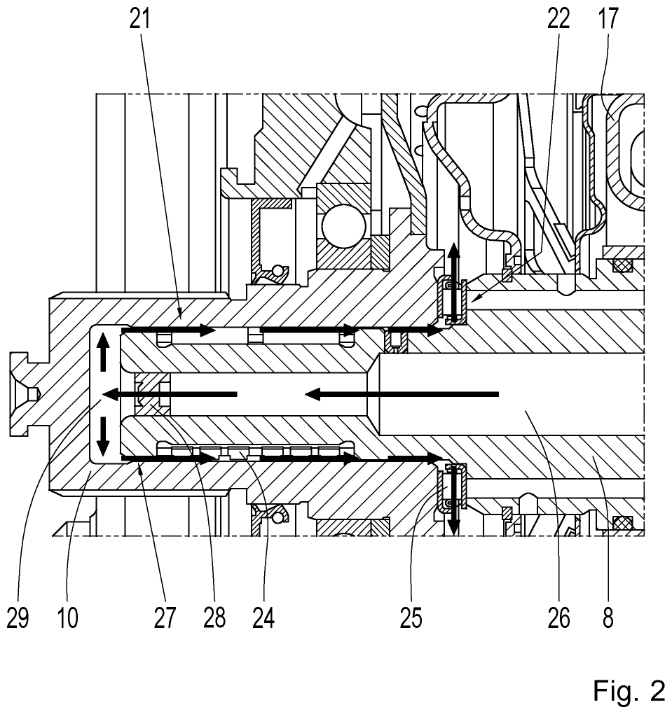

As shown in FIG. 1 and, as more particularly shown in the detailed view in FIG. 2, a flow path (shown with arrows) of the fluid during the supply to the components 21, 22, 23. As is apparent in each case, the fluid within the supply path is initially axially guided via a supply bore 26 in the shaft 8 to an axial end 27 of the shaft 8, where the axial end 27 of the shaft 8 has been axially inserted into the shaft 10. For this purpose, the shaft 10 is a hollow shaft at least in area of the axial end 27 of the shaft. In addition, a nozzle 28 is introduced into the supply bore 26 of the shaft 8 at the axial end 27, the nozzle 28 defining a flow cross-section at the axial end 27.

As particularly shown in FIG. 2, a collecting chamber 29 is defined axially between the shaft 8 and the shaft 10. The fluid flows out of the supply bore 26 via the nozzle 28 into the collecting chamber 29. From this collecting chamber 29, which, together with the supply bore 26, forms a reservoir for the fluid, the fluid then flows radially outward along the shaft 8 initially to the bearing point 24 and, thereafter, also to the bearing point 25 in order to lubricate the bearing points 24, 25. The reservoir, which includes the collecting chamber 29 and the supply bore 26, is referred to in the following as the reservoir 26, 29. Subsequent to the bearing point 25, the fluid then also reaches the separating clutch 4 (FIG. 1). Acting as coolant, the fluid cools the separating clutch 4 here, wherein the main cooling of the separating clutch 4 is ensured via separate paths.

The fluid has at least essentially the same pressure within or along the common supply path. In a non-actuated condition of the separating clutch 4 and, thereby, also of the actuator 15, this pressure is at a low base pressure level, namely a pre-filling pressure level, at which a basic supply to the actuator 15 is carried out. At this low base pressure level and at high rotational speeds of the shaft 8, it is possible, however, that only a reduced amount of the fluid flows into the collecting chamber 29 via the supply bore 26 due to the acting centrifugal force. As a result, the reservoir 26, 29 may run empty and, thereby, the components 21, 22 may be insufficiently supplied. In the extreme case, this even causes air to be suctioned into the collecting chamber 29 and, thereafter, guided to the components 21, 22, 23. In the case of the bearing points 24, 25, a continuous undersupply results in dry running and, thereby, increased wear, as a result of which, in the end, failure of the particular bearing point 24, 25 is imminent.

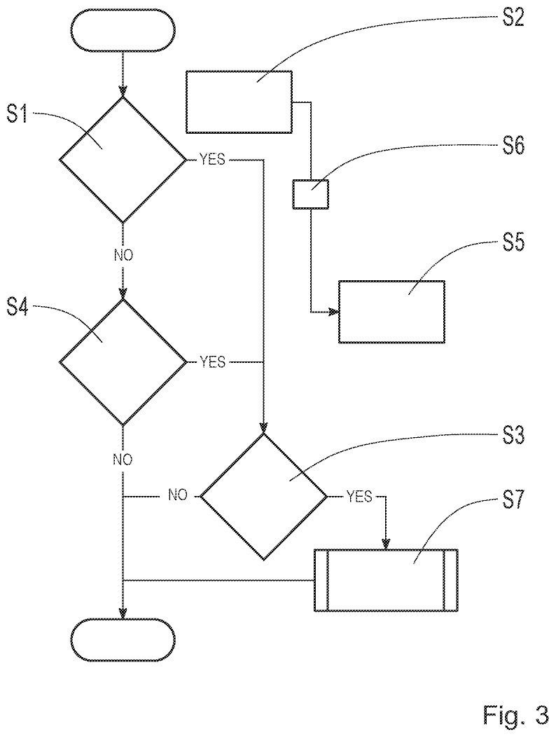

In order to prevent this, an operation of the fluid supply system 20 is carried out in the present case in the manner of a method that is realized according to a preferred embodiment of the invention. The method is preferably carried out by a control unit (not shown further in the present case) of the motor vehicle transmission 9. A flow chart of this method is shown in FIG. 3. As is apparent in FIG. 3, at the beginning of the method, after a start-up of the fluid supply system 20, it is initially checked in a first step S1, as a criterion for an insufficient supply to the components 21, 22, 23, whether there has been a fluid deficit for too long in the reservoir 26, 29 and, thereby, on the inflow side of the components 21, 22, 23. The need for fluid at the components 21, 23 is relevant for this purpose. This need for fluid is dependent, for example, on the rotational speed, the load (traction, coasting) and a gear or gear ratio currently engaged in the motor vehicle transmission 9. Depending on these influencing variables, forces must be supported by the bearing points 24, 25, where the forces determine the need for fluid. For this purpose, a calculation of the fluid deficit is carried out within the scope of a simulation in a substep S2 within the step S1. If a deficit is detected in step S1 and an associated limit value is exceeded with respect to time, the method jumps to a step S3. If a deficit is not detected or the associated limit value is fallen below, a check of a further criterion for an insufficient supply is carried out in a step S4.

In the step S4, which is carried out downstream from or also in parallel with step S1, it is checked whether a critical fill level of fluid has been fallen below in the reservoir 26, 29. For this purpose, a fill level in the reservoir 26, 29 is calculated in a substep S5 within the scope of a simulation. A flow rate of the fluid is incorporated in the simulation of substep S5, the flow rate having been determined in an upstream step S6. Particularly, an amount of fluid flowing into the collecting chamber 29 and/or an amount of fluid flowing out of the collecting chamber 29 are/is determined in step S6. The rotational speed of the shaft 8 yields, or is used to determine, the flow rate of the fluid due to the pressure currently prevailing in the supply path is known, more particularly, on the basis of structure (nozzle design, shaft diameter, etc.) and measurements (as a function of the hydraulic resistances or the viscosity of the oil and of the rotational speed). If it is detected in step S4 on the basis of a comparison with an associated limit value that the critical fill level in the collecting chamber 29 has been fallen below, the method also jumps to step S3. Otherwise, if the result from step S4 is simultaneously negative, the method is terminated.

In step S3, it is checked whether abort conditions are present, where the abort conditions prevent an execution of a measure for ending the insufficient supply to the components 21, 22. These abort conditions are safety-relevant consequences that would arise in the course of the execution of the measure for ending the insufficient supply and could be more serious than a failure of one of the bearing points 24, 25. In addition, an abort condition could also be a comfort-disrupting effect that comes into play when the measure is carried out. In step S3, a plausibility check is therefore carried out to determine whether it is justified to initiate a measure for ending the insufficient supply. If the answer is no, i.e., an abort condition has been met, and the method is also terminated. Otherwise, if no abort condition has been met, the method jumps to a step S7.

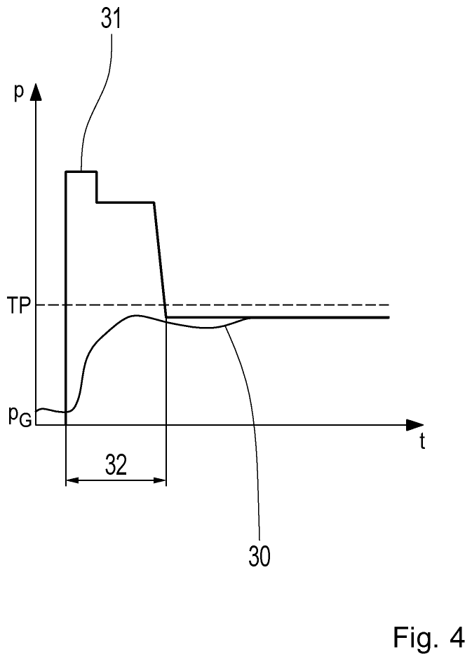

In step S7, the measure for ending the insufficient supply is then carried out, within the scope of which the pressure of the fluid in the supply path is increased even when an actuation of the actuator 15 is not to be carried out. Due to this increase of the pressure starting from the base pressure level, the filling of the reservoir 26, 29 is increased and, thereby, an appropriate supply to the bearing points 24, 25 is also ensured. An exemplary operating sequence of the measure is shown in FIG. 4. FIG. 4 shows a diagram of curves of a pressure p of the fluid in the course of the measure with respect to time t.

As is apparent on the basis of a curve 30 of the actual pressure, the pressure of the fluid at the beginning is initially at the indicated base pressure level pc. A target pressure is specified at the beginning of the measure, however. The target pressure specification is represented as a curve 31 in FIG. 4. Due to this target pressure specification, the actual pressure 30 also increases and settles at a higher pressure level within a rapid filling phase 32 indicated in FIG. 4. A pressure level sets in, at which a touch point TP is approached via the actuating cylinder 16 associated with the separating clutch 4.

The measure in step S7 is carried out as control with pulse width modulation, and so the pressure increase taking place apart from the actuation of the actuator 15 does not take place permanently, but rather in a pulsed manner. After the measure is carried out in step S7, the method is also terminated.

By operation according to the invention of a fluid supply system, an insufficient supply to components, such as, for example, bearing points, is reliably ruled out.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 motor vehicle drive train
2 hybrid module
3 electric machine
4 separating clutch
5 stator
6 rotor
7 rotor hub
8 shaft
9 motor vehicle transmission
10 shaft
11 outer disk carrier
12 outer clutch disks
13 inner clutch disks
14 inner disk carrier
15 actuator
16 actuating cylinder
17 actuating piston
18 pressure chamber
19 spring element
20 fluid supply system
21 component
22 component
23 component
24 bearing point
25 bearing point
26 supply bore
27 axial end
28 nozzle
29 collecting chamber
30 curve
31 curve
32 rapid filling phase
S1 to S7 individual steps
p pressure
t time
p_{G} base pressure level
TP touch point

1-17. (canceled)

18. A method for operating a fluid supply system (20) for integral parts of a motor vehicle drive train (1), the integral parts including at least one actuator (15) and at least one component (21, 22, 23), the at least one actuator (15) and the at least one component (21, 22, 23) being connected in parallel within a supply path of the fluid supply system (20), the method comprising:
increasing a pressure of a fluid in the supply path from a low base pressure level (p_{G}) when the at least one actuator (15) is to be actuated, the low base pressure level (p_{G}) being associated with a non-actuated condition of the at least one actuator (15);
determining, when the at least one actuator (15) is not to be actuated, whether at least one criterion is present, each of the at least one criterion indicating an insufficient supply of the fluid in the supply path to the at least one component (21, 22); and
increasing the pressure of the fluid in the supply path from the low base pressure level (p_{G}) when one or more of the at least one criterion is present.

19. The method of claim 18, wherein determining whether the at least one criterion is present comprises determining that one or more of the at least one criterion is present when an associated limit value is exceeded by a fluid requirement of the at least one component (21, 22).

20. The method of claim 19, further comprising determining the fluid requirement of the at least one component (21, 22) by determining a fluid deficit of the fluid in an inflow-side area of the at least one component (21, 22).

21. The method of claim 19, further comprising determining the fluid requirement of the at least one component (21, 22) by determining a fill level of the fluid in an inflow-side area of the at least one component (21, 22).

22. The method of claim 21, wherein determining the fill level comprises determining an amount of the fluid flowing into the inflow-side area, out of the inflow-side area, or both into and out of the inflow-side area.

23. The method of claim 19, wherein determining the fluid requirement of the at least one component (21, 22) comprises calculating the fluid requirement using a simulation.

24. The method of claim 18, wherein determining whether the at least one criterion is present comprises determining whether the at least one criterion is present based at least in part on one or more operating parameters.

25. The method of claim 18, wherein increasing the pressure of the fluid in the supply path from the low base pressure level (p_{G}) when one or more of the at least one criterion is present comprises increasing the pressure of the fluid in the supply path according to a control with pulse width modulation.

26. The method of claim 18, further comprising determining, upon initiation and prior to increasing the pressure of the fluid in the supply path from the low base pressure level (p_{G}) when one or more of the at least one criterion is present, whether at least one abort condition is met,
wherein, if one or more of the at least one abort condition is present, increasing the pressure of the fluid in the supply path from the low base pressure level (p_{G}) when one or more of the at least one criterion is present is aborted.

27. The method of claim 18, wherein the actuator (15) comprises an actuating cylinder (16) of a separating clutch (4), and the at least one component comprises one or both of a bearing point (24, 25) or the separating clutch (4).

28. The method of claim 27, wherein increasing the pressure of the fluid in the supply path from the low base pressure level (p_{G}) when one or more of the at least one criterion is present comprises increasing the pressure from the low base pressure level (p_{G}) to an actuating pressure level at which a touch point (TP) of the separating clutch (4) is approached via the actuating cylinder (16) of the separating clutch (4).

29. The method of claim 27, wherein increasing the pressure of the fluid in the supply path from the low base pressure level (p_{G}) when one or more of the at least one criterion is present comprises to an intermediate pressure level, the intermediate pressure level being below a minimum actuating pressure at which actuating motion is initiated by the actuating cylinder (16).

30. A fluid supply system (20) for integral parts of a motor vehicle drive train (1), the fluid supply system (20) being operable for supplying fluid to at least one actuator (1) and to at least one component (21, 42, 23) according to the method of claim 18.

31. A transmission control unit associated with a fluid supply system (20), the fluid supply system (20) having a supply path for supplying fluid to at least one actuator (15) and to at least one component (21, 22, 23), the transmission control unit being configured to:
trigger an increase of a pressure of the fluid from a low base pressure level (p_{G}) when the at least one actuator (15) is to be actuated, the low base pressure level (p_{G}) being associated with a non-actuated condition of the at least one actuator (15);
determine, when the at least one actuator (15) is not to be actuated, whether at least one criterion is present, each of the at least one criterion indicating an insufficient supply of the fluid to the at least one component (21, 22); and
initiate an increase in the pressure of the fluid from the low base pressure level (p_{G}) when the one or more of the at least one criterion is detected.

32. A computer program product for the transmission control unit of claim 31, the computing program product comprising software for storing appropriate control commands for implementing a routine for operating the fluid supply system (20).

33. A data carrier comprising the computer program product of claim 32.
